(19) United States
(12) Patent Application Publication
(10) Pub. No.: US 2026/0131976 A1
(43) Pub. Date: May 14, 2026

(54) AN ASSEMBLY AND A METHOD FOR TRANSFERRING A PLURALITY OF GOODS HOLDERS

(71) Applicant: AutoStore Technology AS, Nedre Vats (NO)

(72) Inventor: Jørgen Djuve Heggebø, Langhus (NO)

(21) Appl. No.: 19/119,196

(22) PCT Filed: Sep. 26, 2023
(86) PCT No.: PCT/EP2023/076541

§ 371 Date: Apr. 8, 2025

(30) Foreign Application Priority Data
Oct. 11, 2022 (NO) 20221091

(51) Int. Cl. B65G 1/137; B65G 1/04; B65G 1/06

(52) U.S. Cl. CPC B65G 1/1373; B65G 1/0464; B65G 1/065

(57) ABSTRACT

The invention relates to an assembly (5) for transferring a plurality of goods holders (106) from a first (1) storage and retrieval system to at least one second (2) storage and retrieval system. The assembly (5) comprises a receptacle (10) for holding a plurality of goods holders (106) in a stack, a guideway (15) connecting the first (1) storage and retrieval system and the second (2) storage and retrieval system and a transporter (20) in engagement with the guideway (15), wherein said transporter (15) is configured to transfer the receptacle (10) along the guideway (15) between the first (1) and the at least one second (2) automated storage and retrieval system. The invention further relates to a method for transferring in one go a plurality of goods holders (106).

The present invention relates to assembly for transferring a plurality of goods holders from a first storage and retrieval system to at least one second storage and retrieval system. The invention further relates to method for transferring a plurality of goods holders stacked in a receptacle from a first storage and retrieval system to at least one second storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

In the context of above-discussed WO2014/075937A1, dealing with removal of storage bins from the system, WO2019/086237 discloses a storage system in which storage bins are removed sideways. More specifically, storage bins are transported between a main storage area and an external deployment area by means of a complex train solution. The train solution comprises a car train with bins positioned on individual cars such that a horizontal array of bins is achieved. The front car of the car train is motorized.

In a related context, AT524109 discloses a main storage system and a therewith associated transfer station where individual stored articles are transferred to totes for further transfer by means of a conveyor system. The bins themselves remain within the main storage system. The solution of AT524109 is also prohibitively complex, featuring totes acting as intermediary storage means.

WO2016/166294 discloses an object handling system comprising a grid above a workspace filled with stacked containers. The system further comprises load handling devices moving around the grid and lifting/lowering a container from the stack. As shown in FIG. 4 of WO2016/166294, a wheeled roll cage may be used in order to attach/detach a plurality of container stacks with respect to the grid. Properly aligning the roll cage prior to docking to the workspace is tedious. Moreover, securing, typically latching, the roll cage when docked to the workspace is necessary in order to prevent it from rolling away.

EP0767113B1 discloses a robot system comprising a robot movable in a plane above a working area in which storage bins are arranged in vertical stacks. The robot has a vertically movable tubular picking device for enabling at least one storage bin to be picked from or unloaded onto a stack of the working area. The picking device has a load space dimensioned to enclose and carry a plurality of stacked storage bins. As seen in FIG. 2 of EP0767113B1, the robot can only move the storage bins around the working area and is not able to extract them from said area. Moreover, the general construction of the system of EP0767113B1 entails that, when said system is used in an enclosed space such as a warehouse, the maximum number of the individual stacks to be picked/unloaded is limited by the size, i.e. height, of the picking device.

In view of the above, it is desirable to provide a solution that solves or at least mitigates aforementioned problems belonging to the prior art.

### SUMMARY OF THE INVENTION

The present invention is set forth and characterized in the independent claims, while the dependent claims describe other characteristics of the invention.

A first aspect of the invention relates to an assembly for transferring a plurality of goods holders from a first storage and retrieval system to at least one second storage and retrieval system, said assembly comprising: a receptacle for holding a plurality of goods holders in a stack, a closed-path guideway connecting the first storage and retrieval system and the second storage and retrieval system and a transporter in engagement with the guideway, wherein said transporter is configured to transfer the container along the guideway between the first and the at least one second automated storage and retrieval systems.

By providing an assembly in accordance with the first aspect of the invention, an efficient solution for goods holder transfer is achieved as a plurality of goods holders arranged in a single receptacle may be moved in one go.

Furthermore, and as space is scarce in most storage and retrieval systems, a solution fully exploiting vertical dimension of the available space and resulting in an assembly having a small footprint confers significant advantages over prior art.

In addition and with reference to the systems of WO2019/086237 and EP0767113B1, a further advantage conferred by the invention is that a constructionally simple solution having few moving parts is obtained.

The proposed solution is easily integrated in new/existing storage and retrieval systems and the assembly in accordance with the first aspect of the invention ties in well with standard goods holders/remotely operated vehicles such as those shown in FIGS. 2-3b. By way of example, the standard vehicle interacts with the assembly by inserting/extracting ordinary goods holders via an open top side of the receptacle.

Finally, the proposed solution is particularly suitable in the context of a plurality of smaller, peripheral storage units, for instance micro-fulfillment centers (MFC), connected with a large, central storage unit, wherein, for efficient operation, the peripheral units require continuous article supply/replenishment from the central unit.

Another aspect of the invention relates to a method for transferring a plurality of goods holders stacked in a receptacle from a first storage and retrieval system to at least one second storage and retrieval system, in accordance with claim 25. For the sake of brevity, advantages discussed above in connection with the assembly for transferring a plurality of goods holders may even be associated with the corresponding method and are not further discussed. Here, it is to be construed that the sequence of method steps of method claims may be effectuated in any given order.

For the purposes of this application, the term “container handling vehicle” used in “Background and Prior Art”-section of the application and the term “remotely operated vehicle” used in “Detailed Description of the Invention”-section both define an autonomous wheeled vehicle operating on a rail system arranged across the top of the framework structure being part of an automated storage and retrieval system.

Analogously, the term “storage container” used in “Background and Prior Art”-section of the application and the term “goods holder” used in “Detailed Description of the Invention”-section both define a vessel for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4a is a perspective view showing an assembly for transferring a plurality of goods holders according to an embodiment of the present invention as well as framework structure.

FIG. 4b is a side view of the assembly shown in FIG. 4a.

FIG. 4c is a perspective view of a receptacle for holding a plurality of goods holders in a stack.

FIG. 4d is a perspective view showing an assembly for transferring a plurality of goods holders according to another embodiment of the present invention.

FIG. 4e is a perspective view showing an assembly for transferring a plurality of goods holders according to yet another embodiment of the present invention.

FIG. 4f is a side view of the assembly shown in FIG. 4e.

FIG. 5a shows a transporter in engagement with a guideway and means for coupling said transporter to a receptacle of an assembly according to the embodiment shown in FIGS. 4a-4b. FIG. 5a further shows a portion of a receptacle shown in FIG. 4c and a portion of a remotely operated vehicle.

FIG. 5b is a close-up of the transporter and means for coupling shown in FIG. 5a.

FIG. 6a is a perspective view of a transporter and means for coupling according to the embodiment shown in FIGS. 4e-4f.

FIG. 6b is a cross-sectional view of the transporter and means for coupling shown in FIG. 6a.

FIGS. 7a-7b show a transporter and means for coupling said transporter to a receptacle of an assembly according to another embodiment of the present invention.

FIG. 7c shows the transporter of FIGS. 7a-7b when coupled to the receptacle.

FIGS. 8-9 show a guideway having added functionality as a goods holder buffer.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

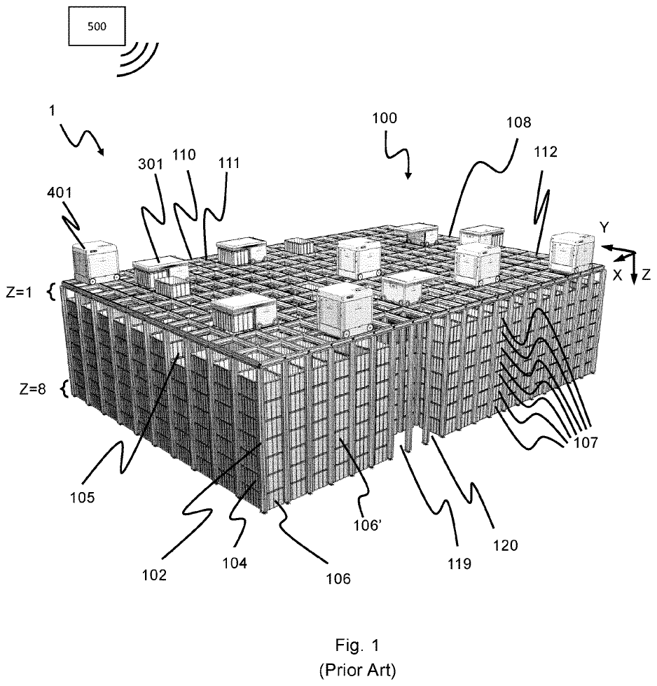

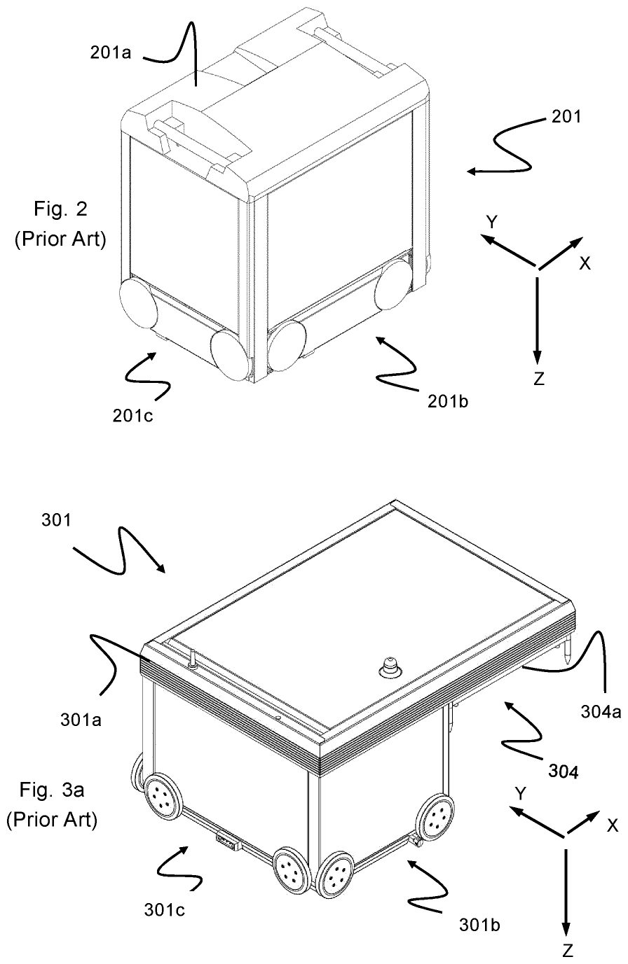

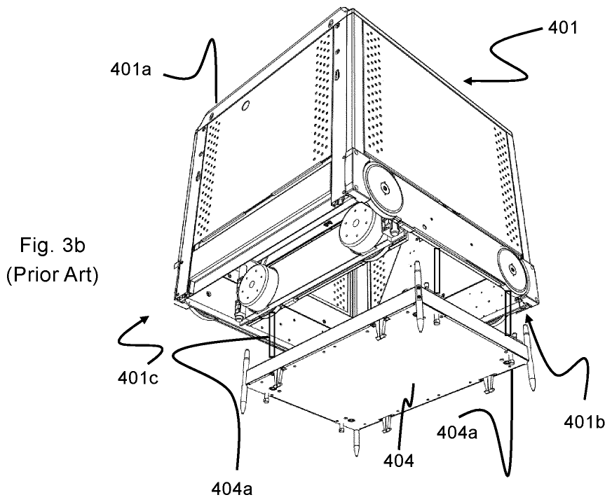

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X-direction and Y-direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than what is disclosed in FIG. 1. For example, the framework structure 100 may have a horizontal extent of more than 700×700 columns and a storage depth of more than twelve containers.

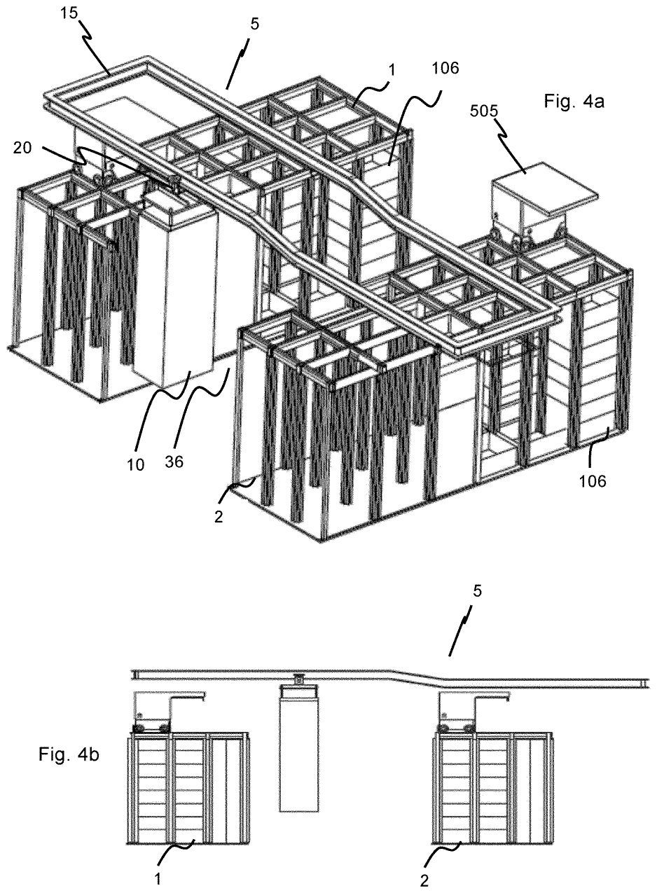

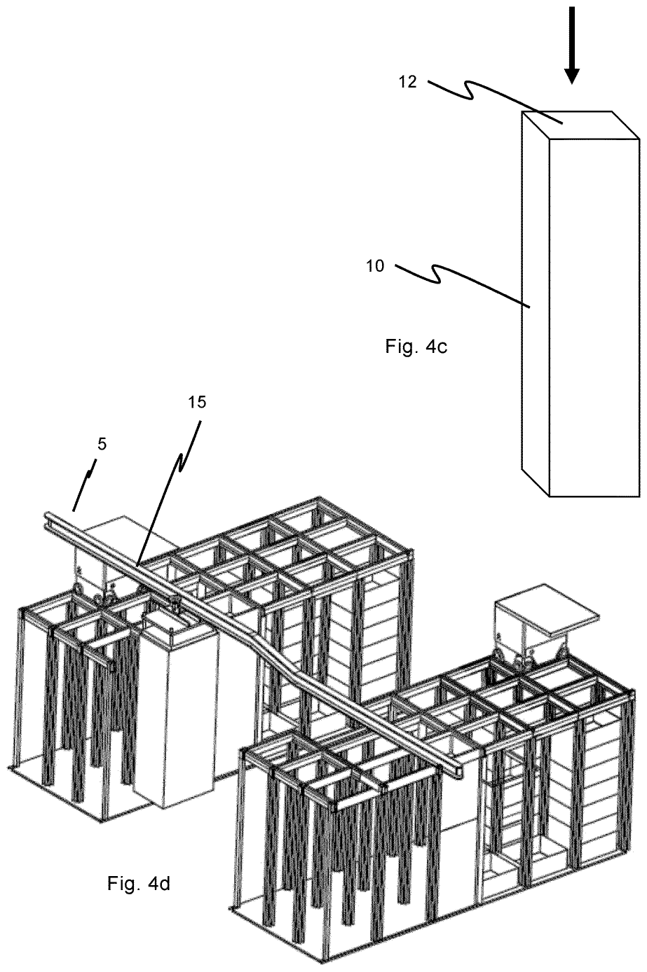

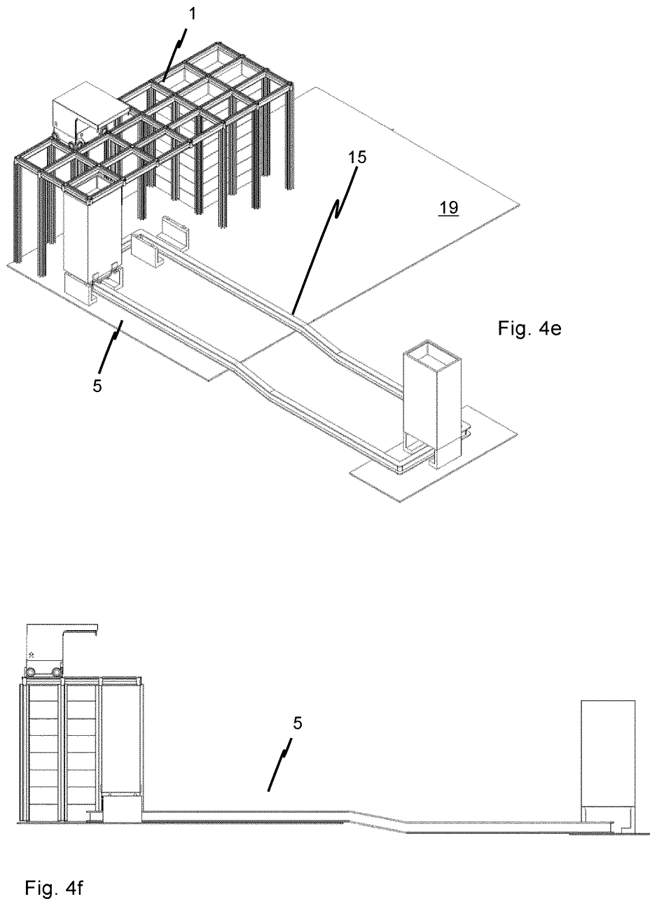

Various aspects of the present invention will now be discussed in more detail with reference to FIGS. 4a-7c.

FIG. 4a is a perspective view showing an assembly 5 for transferring a plurality of goods holders 106 according to an embodiment of the present invention as well as a plurality of storage systems 1, 2.

More specifically, it is shown a first storage and retrieval system 1 and, at a distance, a second storage and retrieval system 1. In both systems 1, 2 goods holders 106 are stored. A closed-path guideway 15 of the assembly 5 for transferring a plurality of goods holders 106 connects the systems 1, 2. The assembly 15 further comprises a vertically extending receptacle 10 for holding a plurality of goods holders 106 in a stack. A transporter 20 of the assembly 5 is in engagement with the guideway 15. The transporter 20 is configured to transfer the receptacle 10 (filled with goods holders or empty) along the guideway 15 such that goods holders 106 are movable between the first 1 and the second 2 automated storage and retrieval system. Accordingly and with reference to the systems belonging to state of the art, a constructionally simple solution having few moving parts is obtained.

In one embodiment, at least one of the first 1 and the second 2 automated storage and retrieval systems is a so-called micro-fulfillment center (MFC). In this context, it is advantageous to provide a plurality of smaller, peripheral systems serving as micro-fulfillment centers and a large central system of the type discussed in connection with FIG. 1 that continuously and efficiently replenishes the smaller peripheral systems by means of the assembly able to transfer a plurality of goods holders in one go.

Still with reference to FIG. 4a, a goods holder 106 is inserted into the receptacle 10 or extracted from the receptacle 10 from above via an open top side (see FIG. 4c) of the receptacle 10 by means of a conventional remotely operated vehicle 505 operating on a rail system 108 of a framework structure 100 (both shown in FIG. 1). As easily inferred, the receptacle's direction of transfer between the first 1 and the second 2 storage retrieval system is perpendicular to the direction of insertion/extraction of the goods holder 106. Here, the proposed solution is easily integrated in new/existing storage and retrieval systems and the assembly 5 ties in well with standard goods holders/remotely operated vehicles.

As visible in FIG. 4a, the guideway 15 of the assembly 5 is disposed so as to overlie the first 1 and the second 2 automated storage and retrieval systems. Clearly, this liberates a lot of floor space. In the shown embodiment, the guideway 15 is an I/H-beam, but other guideway shapes are equally conceivable. The guideway 15 is substantially horizontally arranged. However, embodiments comprising significant height differences between the first 1 and the second 2 automated storage and retrieval system are equally conceivable. In the shown embodiment, the guideway 15 extends above at least part of the first 1 and second 2 systems. Furthermore, in the shown embodiment the guideway 15 extends at an angle to the horizontal over at least part of its extent between the first 1 and second 2 systems. In another embodiment (not shown), the guideway only extends between opposite edges of the systems and does not overlap with the framework of the respective system.

Normally, each automated storage and retrieval system 1, 2 comprises a transfer area 36 where actual inserting/extracting of goods holders 106 takes place. The receptacle 10 is coupled to/uncoupled from the transporter 20 in the transfer area 36.

FIG. 4b is a side view of the assembly 5 shown in FIG. 4a. As easily seen, the receptacle 10 holding a stack of goods holders (filled or empty) is suspended from the transporter 20 that is in engagement with the guideway 15.

With reference to FIGS. 4a-4b in conjunction with FIG. 1, the storage and retrieval system 1 of the type shown in FIG. 1 could comprise the assembly 5 for transferring a plurality of goods holders to another storage and retrieval system 2 of the type shown in FIG. 1.

FIG. 4c is a perspective view of a receptacle 10 for holding a plurality of goods holders in a stack. The receptacle 10 has an open top side 12 for inserting or extracting goods holders in a vertical direction (by means of the remotely operated vehicle shown and briefly discussed in connection with FIGS. 4a-4b) denoted by an arrow. As space is scarce in most storage and retrieval systems, the receptacle 10 of FIG. 4c in connection with an overlying, previously discussed, guideway fully exploits vertical dimension of the available space, liberates a lot of floor space and results in an assembly having a small footprint conferring significant advantages over prior art.

FIG. 4d is a perspective view showing an assembly 5 for transferring a plurality of goods holders according to another embodiment of the present invention. For the sake of brevity, the parts discussed above in connection with FIGS. 4a-4b are not further discussed in connection with FIG. 4d. In FIG. 4d, a guideway 15 is a straight rail connecting the systems. Transfer of goods holders takes place in a manner similar to that discussed in conjunctions with FIGS. 4a-4b. Obviously, in this configuration, there can only be one receptacle being transferred at a time along the guideway 15.

FIG. 4e is a perspective view showing an assembly 5 for transferring a plurality of goods holders according to yet another embodiment of the present invention. For the sake of brevity, the parts discussed above in connection with FIGS. 4a-4d are not further discussed in connection with FIG. 4e. In FIG. 4e, a single storage and retrieval system 1 is shown. As seen, the guideway 15 is disposed on the floor 19. The guideway 15 may be fixedly fastened to the floor 19 by means of suitable fastening means. In a preferred embodiment, the guideway 19 is a rail that is inset level with floor surface.

FIG. 4f is a side view of the assembly 5 shown in FIG. 4e.

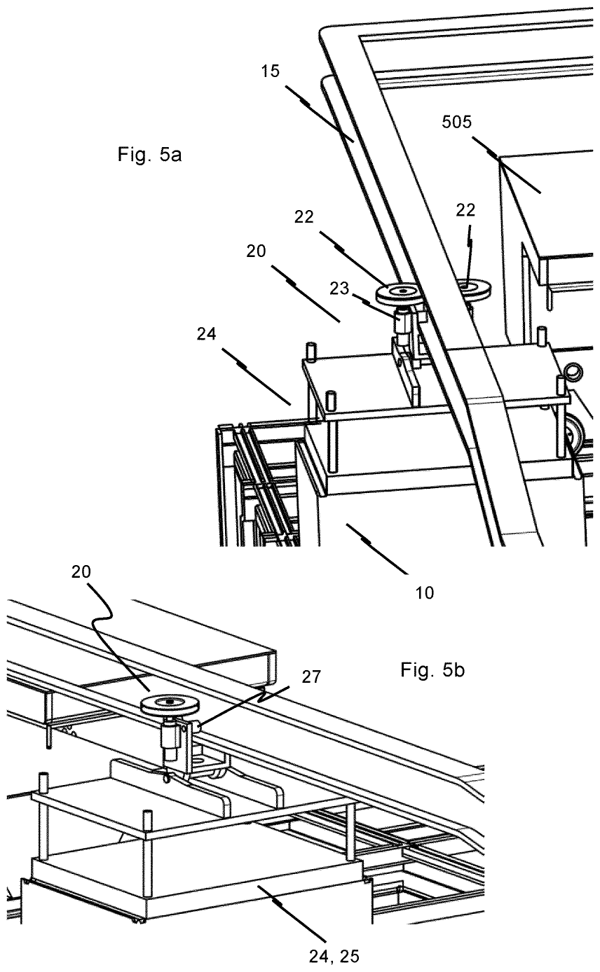

FIG. 5a shows a transporter 20 in engagement with a guideway 15 and means 24 for coupling said transporter 20 to a receptacle 10 of an assembly 5 according to an embodiment of the present invention. A portion of a remotely operated vehicle 505 is also shown. For the sake of brevity, the parts discussed above in connection with FIGS. 4a-4f are not further discussed in connection with FIG. 5a. As seen, the transporter 20 is in rolling engagement with the guideway 15. The guideway 15 comprises a rail, for instance shown I/H-beam, which is in engagement with a pair of oppositely arranged wheels 22 of the transporter 20. Rotation of these horizontally oriented wheels 22 moves the transporter 20. A motor 23 for rotating each wheel 22 is arranged below each wheel 22. A non-driven support wheel (27, visible in FIG. 5b) abuts a lower flange of the beam 15. This wheel 27 ensures that the moving transporter 20 stays in correct position with respect to the beam. FIG. 5a further shows a portion of a receptacle 10 shown in FIG. 4c.

In addition to rolling engagement shown in FIG. 5a, other solutions are envisagable, for instance the transporter 20 being in sliding engagement with the guideway 15.

FIG. 5b is a close-up of the transporter 20 and means 24 for coupling shown FIG. 5a. Said coupling means 24 are for releasably coupling the transporter 20 to the receptacle 10. The means 24 are fixedly attached to a section of the transporter 20 facing away from the guideway 15 when the receptacle 10 is suspended as shown in FIG. 5b. In the shown, non-limiting, embodiment said means comprises a plate 25 for coupling to the receptacle 10, said plate 25 being arranged to slide into two oppositely positioned grooves (not shown) arranged in the receptacle 10. Once the plate 25 is in correct position and the receptacle 10 is positioned below the transporter 20, the plate 25 is locked/immobilized using means (not shown) for locking the plate 25 relative to the receptacle.

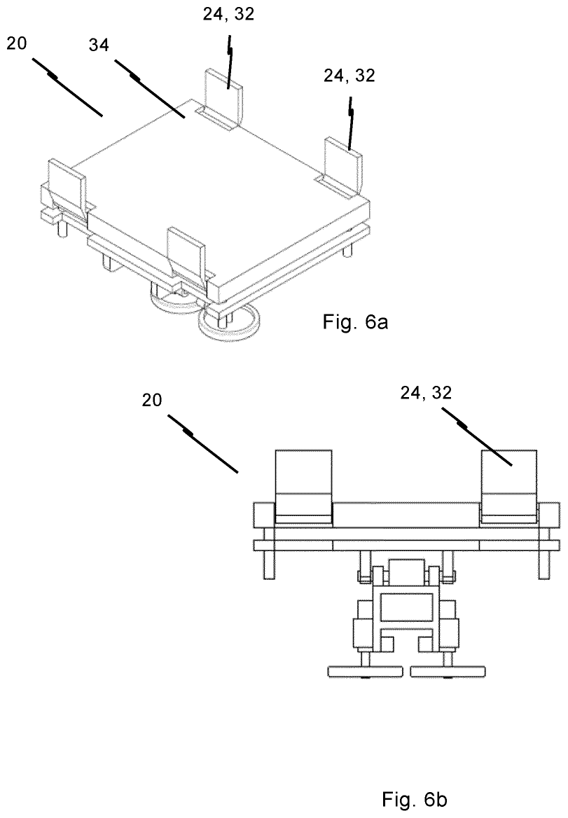

FIG. 6a is a perspective view of a transporter 20 and means 24 for coupling according to the embodiment shown in FIGS. 4e-4f. Said coupling means 24 are for releasably coupling the transporter 20 to the previously discussed receptacle 10. As shown in FIG. 4e, the means 24 are fixedly attached to a section of the transporter facing away from the guideway. In one, non-limiting embodiment said means 24 comprises a plurality of oppositely arranged clamping elements 32 configured to clamp the receptacle (shown in FIG. 4c) positioned on a support plate 34 being part of the transporter 20. Typically, the clamping elements 32 are spring-loaded and their side facing the receptacle in coupled state is coated with high-friction material.

FIG. 6b is a cross-sectional view of the transporter 20 and clamping elements 32 shown in FIG. 6a. For the sake of brevity, the parts discussed above in connection with FIG. 6a are not further discussed in connection with FIG. 6a. In addition to the transporter parts discussed above, further parts of the transporter 20 are not discussed in greater detail and the person skilled in the art is well acquainted with their structure and function.

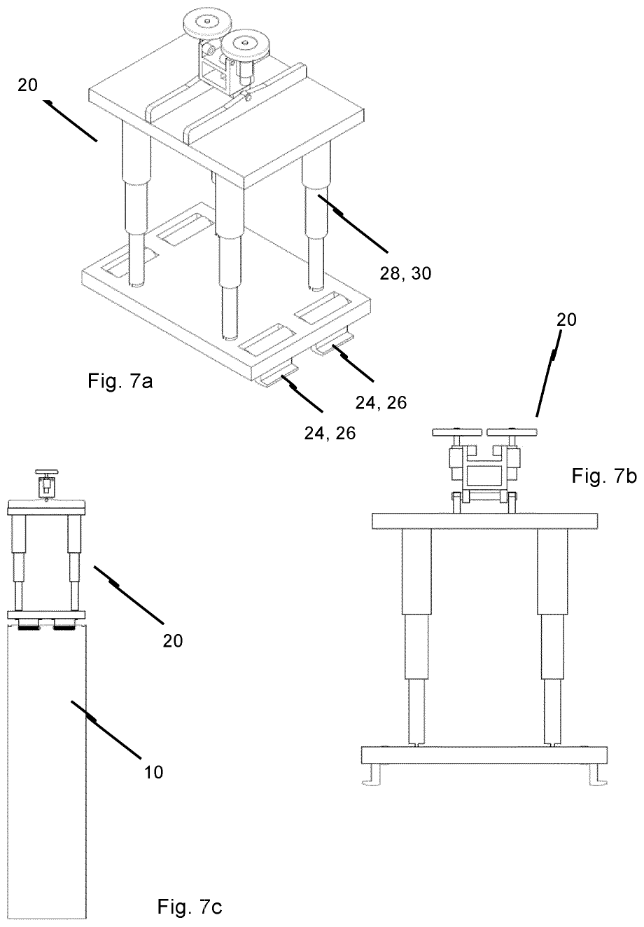

FIGS. 7a-7b show a transporter 20 and means 24 for coupling said transporter 20 to a receptacle 10 of an assembly 5 and means 28 for vertically displacing the receptacle. For the sake of brevity, the parts discussed above in connection with FIGS. 4a-6b are not further discussed in connection with FIGS. 7a-7b.

With reference to FIG. 7a, said means 24 for releasably coupling said transporter 20 to the receptacle comprises oppositely arranged gripping elements 26. Typically, the gripping elements 26 are spring-loaded. Each gripping element 26 is configured to grip into corresponding recess (not shown) arranged in the receptacle (shown in FIG. 4c). FIG. 7a further shows means 28 for vertically displacing the receptacle. In the shown embodiment, said means 28 for vertically displacing the receptacle is a plurality of telescopic arms 30.

FIG. 7b is a cross-sectional view of the transporter 20 and means for coupling/vertically displacing shown in FIG. 7a, while FIG. 7c shows the transporter 20 of FIGS. 7a-7b when coupled to the receptacle 10. Again, further parts of the transporter 20 are not discussed in greater detail and the person skilled in the art is well acquainted with their structure and function.

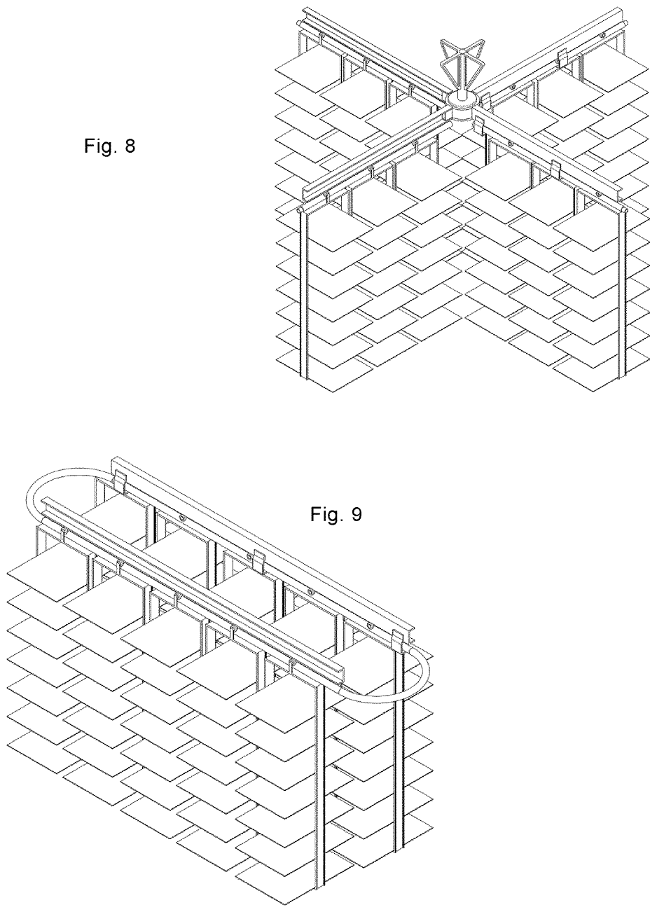

With respect to previously-discussed guideway, slightly modified guideway, i.e. provided with shelves, may obtain added functionality by being be employed as a goods holder buffer in a goods holder queue management application. Such solutions are shown in FIG. 8 (showing a carousel-style goods holder buffer) and FIG. 9 (showing a ring-shaped goods holder buffer).

In the preceding description, various aspects of the assembly 5 for transferring a plurality of goods holders 106 according to the invention have been described with reference to the illustrative embodiments. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### List of Reference Numbers

1 First storage and retrieval system
2 Second storage and retrieval system
5 Assembly
10 Receptacle
12 Top side
15 Guideway
17 Rail
19 Floor
20 Transporter
22 Driven wheel
23 Wheel motor
24 Means for releasably coupling said transporter to the receptacle
25 Plate
26 Gripping element
27 Support wheel
28 Means for vertically displacing the receptacle
30 Telescopic arm
32 Clamping element
34 Support plate
36 Transfer area
100 Framework structure
101 Storage cell
101′ Storage cell of the storage column module
102 Upright members of framework structure
102′ Upright members of the framework structure of the module
104 Storage grid
105 Storage column
105′ Storage column of the storage column module
106 Storage container/Goods holder
107 Stack of storage containers
108 Rail system
110 Parallel rails in first direction (X)
111 Parallel rails in second direction (Y)
112 Access opening
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
500 Control system
505 Remotely operated vehicle
X First direction
Y Second direction
Z Third direction

1-32. (canceled)

33. An assembly for transferring a plurality of goods holders from a first storage and retrieval system to at least one second storage and retrieval system, said assembly comprising:
a receptacle for holding a plurality of goods holders in a stack,
a guideway connecting the first storage and retrieval system and the second storage and retrieval system, and
a transporter in engagement with the guideway, wherein said transporter is configured to transfer the receptacle along the guideway between the first and the at least one second automated storage and retrieval systems.

34. The assembly of claim 33, wherein the transporter is in rolling engagement with the guideway.

35. The assembly of claim 33, wherein the guideway comprises a rail which is in engagement with at least one wheel of the transporter.

36. The assembly of claim 33, wherein the receptacle has an open top side for inserting or extracting goods holders in a vertical direction.

37. The assembly of claim 33, wherein the receptacle's direction of transfer between the first and the second storage retrieval systems is perpendicular to the direction of insertion/extraction of the goods holder.

38. The assembly of claim 33, wherein the goods holder is inserted or extracted from above by means of a remotely operated vehicle operating on a rail system of a framework structure of the first or the second automated storage and retrieval systems.

39. The assembly of claim 33, the assembly comprising means for releasably coupling said transporter to the receptacle, said means being fixedly attached to a section of the transporter facing away from the guideway.

40. The assembly of claim 33, wherein the guideway is disposed above the first and the second automated storage and retrieval systems.

41. The assembly of claim 33, wherein the receptacle is suspended from the transporter.

42. The assembly of claim 33, wherein said means for releasably coupling said transporter to the receptacle comprises a plate.

43. The assembly of claim 42, wherein said plate is configured to slide into two oppositely positioned grooves arranged in the receptacle.

44. The assembly of claim 43, the assembly comprising means for locking the plate relative to the receptacle.

45. The assembly of claim 33, wherein said means for releasably coupling said transporter to the receptacle comprises oppositely arranged gripping elements.

46. The assembly of claim 45, wherein each of said gripping elements is configured to grip into corresponding recess arranged in the receptacle.

47. The assembly of claim 33, the assembly comprising means for vertically displacing the receptacle.

48. The assembly of claim 47, wherein said means for vertically displacing the receptacle is a plurality of telescopic arms.

49. The assembly of claim 33, wherein the guideway is disposed on a floor.

50. The assembly of claim 49, wherein said means for releasably coupling said transporter to the receptacle comprises a plurality of oppositely arranged clamping elements configured to clamp the receptacle positioned on a support plate being part of the transporter.

51. The assembly of claim 33, wherein at least one of the first and the at least one second automated storage and retrieval systems is a micro-fulfillment center (MFC).

52. The assembly of claim 33, wherein said guideway is a closed-path guideway.

53. A storage and retrieval system comprising a framework structure that comprises a plurality of storage columns for accommodating goods holders, wherein a rail system is arranged across a top of the framework structure, the goods holders being inserted in the storage columns by means of at least one remotely operated vehicle operating on the rail system, the automated storage and retrieval system further comprising an assembly for transferring a plurality of goods holders to at least one second storage and retrieval system in accordance with claim 33.

54. The storage and retrieval system of claim 53, wherein at least one of the first and the at least one second automated storage and retrieval systems comprises a transfer area where goods holders are inserted into the receptacle or extracted from the receptacle.

55. The storage and retrieval system of claim 54, wherein the receptacle is configured to be coupled to the transporter in one of the transfer areas before being transported from the first to the at least one second automated storage and retrieval system and/or is configured to be uncoupled from the transporter in a transfer area after being transported from the first to the at least one second automated storage and retrieval system.

56. A higher-level system comprising a first storage and retrieval system and a second storage and retrieval system, wherein the first and the second storage and retrieval systems are connected by the assembly in accordance with claim 33.

57. A method for transferring a plurality of goods holders stacked in a receptacle from a first storage and retrieval system to at least one second storage and retrieval system, the method comprising:
coupling the receptacle to a transporter; and
moving the transporter and the receptacle along a guideway extending from the first storage and retrieval system to the at least one second storage and retrieval system.

58. The method of claim 57, wherein coupling the receptacle to the transporter comprises sliding a plate being fixedly attached to a section of the transporter into two oppositely positioned grooves arranged in the receptacle.

59. The method of claim 57, wherein coupling the receptacle to the transporter comprises inserting oppositely arranged gripping elements into corresponding recesses arranged in the receptacle.

60. The method of claim 57, wherein coupling the receptacle to the transporter comprises clamping the receptacle positioned on a support plate being part of the transporter.

61. The method of claim 57, the method further comprising vertically displacing the receptacle coupled to the transporter.

62. The method of claim 57, the method further comprising, once the receptacle has been transferred to the at least one second storage and retrieval system, decoupling the receptacle from the transporter.

63. The method of claim 57, the method further comprising, once the receptacle is uncoupled, inserting goods holders into the receptacle and/or extracting goods holders from the receptacle.

64. The method of claim 57, the method comprising, once the goods holders are inserted into the receptacle and/or extracted from the receptacle, returning the receptacle from the at least one second storage and retrieval system to the first storage and retrieval system along the guideway.
